(19) United States
(12) Patent Application Publication
(10) Pub. No.: US 2020/0377652 A1
(43) Pub. Date: Dec. 3, 2020

(54) HIGH MOLECULAR WEIGHT POLYOXYALKYLENE WITH LOW GLASS TRANSITION TEMPERATURE, PRODUCED BY THE GRAFTING THROUGH METHOD

(71) Applicant: Covestro Deutschland AG, Leverkusen (DE)

(72) Inventors: Thomas Ernst Mueller, Aachen (DE); Christoph Guertler, Köln (DE); Muhammad Afzal Subhani, Aachen (DE); Burkhard Köhler, Zierenberg (DE); Walter Leitner, Aachen (DE)

(21) Appl. No.: 16/763,010

(22) PCT Filed: Nov. 20, 2018
(86) PCT No.: PCT/EP2018/081837

§ 371 Date: May 11, 2020

(30) Foreign Application Priority Data
Nov. 23, 2017 (EP) 17203362.3

(51) Int. Cl. C08G 65/26; C08G 64/34; C08G 64/02

(52) U.S. Cl. CPC C08G 65/2603; C08G 64/0291; C08G 64/34

(57) ABSTRACT

A method for preparing polyoxyalkylene monomers, comprising the step of the reaction of one or more H-functional starter substance(s), one or more alkylene oxides and carbon dioxide in the presence of a DMC catalyst is characterized in that at least one of the H-functional starter substance(s) comprises a carbon-carbon double bond, wherein the carbon-carbon double bond is part of a cyclic structure. The macromonomers obtained can be used in a method for preparing polyoxyalkylene brush polymers, wherein this method comprises the step of the reaction with an olefin metathesis catalyst. The polyoxyalkylene brush polymers obtained may subsequently be crosslinked.

The present invention relates to a process for preparing polyoxyalkylene macromers, to a process for preparing polyoxyalkylene brush polymers and to a process for preparing crosslinked polyoxyalkylene polymers and also to the polymers obtainable by these processes.

The preparation of polyethercarbonate polyols by catalytic reaction of alkylene oxides (epoxides) and carbon dioxide in the presence of H-functional starter substances (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown schematically below, where R is an organic radical such as alkyl, alkylaryl or aryl, each of which may also contain heteroatoms, for example O, S, Si, etc., and where e, f and g are each integers, and where the product shown here in the scheme for the polyethercarbonate polyol should be understood merely as meaning that blocks having the structure shown can in principle be present in the polyethercarbonate polyol obtained, but the order, number and length of the blocks and also the OH functionality of the starter may vary and is not restricted to the polyethercarbonate polyol shown in the scheme. This reaction is environmentally very advantageous, since this reaction constitutes the conversion of a greenhouse gas such as CO₂ into a polymer. A further product formed, actually a by-product, is the cyclic carbonate shown in the scheme (for example, when R═CH₃, propylene carbonate).

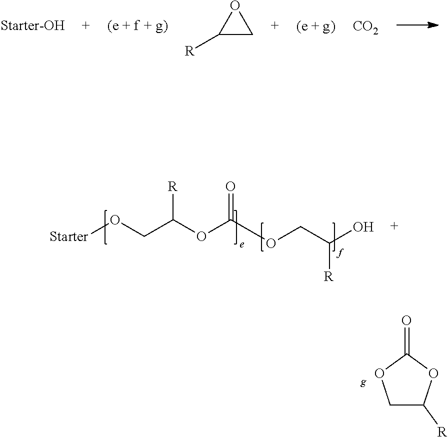

In the course of the synthesis of graft copolymers, a strategy of interest is that known as “grafting through”, in which polymers functionalized with olefinic end groups are functionalized further. U.S. Pat. No. 5,109,075 discloses comb-form graft copolymers of allyl-terminated macromolecular polyether monomers. In addition, G. W. Coates in Macromol. 2012, 45, 7878-7883, describes the preparation of polycyclohexylenecarbonate macromers, monoterminated with a norbornenecarboxylic ester group, which were copolymerized with the aid of a ring-opening metathesis polymerization (ROMP) to give a brush polymer. The preparation of the macromers requires β-diiminate zinc complexes which are obtainable technically only with difficulty. In addition, the macromers and the resulting brush polymer have a glass transition temperature far above 0° C. as a result of the choice of the monomers (substituted cyclohexene oxides) and as a result of the alternating copolymerization that is typical for zinc complexes. Polynorbornene prepared by means of ROMP has a glass transition temperature of ±35° C. (see JP 02022354). A high glass transition temperature limits the range of use of the polymers obtained. For instance, the polymers are by way of example not suitable for elastomer applications.

Polyethercarbonates prepared by copolymerization of epoxides and CO₂ using DMC (double metal cyanide) catalysts have, in particular when incorporating α-olefin oxides and/or glycidyl ethers as comonomers (WO2015032717 (A1)), low glass transition temperatures. However, only low molar masses of up to 10 000 g/mol are achieved. Such polyethercarbonates are unsuitable for elastomer applications. For high molecular weight polyethercarbonates, distillative removal of the cyclic alkylene carbonates formed as by-product is also hindered.

It was therefore an object to provide, using an industrially readily available catalyst, a low molecular weight polyoxyalkylene macromer which can be readily freed of by-products such as cyclic alkylene carbonates by means for example of thin-film distillation. In addition, this macromer should subsequently be able to be built up into a high molecular weight polymer.

According to the invention, the object is achieved by a process for preparing polyoxyalkylene macromers, comprising the step of reacting one or more H-functional starter substances and one or more alkylene oxides in the presence of a catalyst, wherein at least one of the H-functional starter substances comprises a carbon-carbon double bond which is part of a cyclic structure and wherein the starter substance and the alkylene oxide are metered continuously into the reactor during the reaction.

Catalysts according to the invention can be alkali metal hydroxides, alkaline earth metal hydroxides, primary amines, secondary amines, tertiary amines, Bronsted acids or double metal cyanide catalysts (“DMC catalysts”).

Within the context of the present invention, the term “macromer” means a “macromolecular monomer”, that is to say a macromolecule which is capable of reacting with further macromolecules. In the present case, this may be effected by means of ring-opening metathesis polymerization (“ROMP”) via cyclic double bonds present in the macromer. The macromers used according to the invention are preferably monofunctional in terms of the ROMP-capable group. However, higher-functionality macromers or mixtures of monofunctional and higher-functionality macromers may also be used.

For the purposes of the present invention, “polyoxyalkylene macromers” encompass polyether macromers, polyethercarbonate macromers, polyetherester macromers, polyetherestercarbonate macromers.

The DMC catalyst can be added in solid form or in a suspension medium which comprises no H-functional groups, or in suspension in one or more H-functional starter substances. If the DMC catalyst is added as a suspension, it is added preferably in step (α1) to the suspension medium and/or to the one or more H-functional starter substances.

The catalyst used for the preparation of the low-viscosity polyethercarbonate polyols of the invention having side chains is, as stated, preferably a DMC catalyst (double metal cyanide catalyst). Additionally or alternatively, it is also possible to use other catalysts for the copolymerization of alkylene oxides and CO2 active catalysts, such as for example zinc carboxylates or cobalt-salen complexes. Examples of suitable zinc carboxylates are zinc salts of carboxylic acids, especially dicarboxylic acids such as adipic acid or glutaric acid. An overview of the known catalysts for the copolymerization of alkylene oxides and CO2 is provided for example by Chemical Communications 47 (2011) 141-163.

The catalyst used for the preparation of the low-viscosity polyethercarbonate polyols of the invention having side chains is, as stated, preferably a DMC catalyst (double metal cyanide catalyst). Additionally or alternatively, it is also possible to use other catalysts for the copolymerization of alkylene oxides and CO₂ active catalysts, such as for example zinc carboxylates or cobalt-salen complexes. Examples of suitable zinc carboxylates are zinc salts of carboxylic acids, especially dicarboxylic acids such as adipic acid or glutaric acid. An overview of the known catalysts for the copolymerization of alkylene oxides and CO₂ is provided for example by Chemical Communications 47 (2011) 141-163.

The double metal cyanide compounds present in the DMC catalysts usable with preference in the process according to the invention are the reaction products of water-soluble metal salts and water-soluble metal cyanide salts.

Double metal cyanide (DMC) catalysts are known from the prior art for the homopolymerization of alkylene oxides (see, for example, U.S. Pat. Nos. 3,404,109, 3,829,505, 3,941,849 and 5,158,922). DMC catalysts, which are described, for example, in U.S. Pat. No. 5,470,813, EP-A 700 949, EP-A 743 093, EP-A 761 708, WO 97/40086 A1, WO 98/16310 A1 and WO 00/47649 A1, possess a very high activity and allow the preparation of polyethercarbonate polyols at very low catalyst concentrations. A typical example is that of the highly active DMC catalysts described in EP-A 700 949 which, as well as a double metal cyanide compound (e.g. zinc hexacyanocobaltate(III)) and an organic complex ligand (e.g. tert-butanol), also contain a polyether having a number-average molecular weight greater than 500 g/mol.

The DMC catalysts which can be used in accordance with the invention are preferably obtained by

(a) in the first step reacting an aqueous solution of a metal salt with the aqueous solution of a metal cyanide salt in the presence of one or more organic complex ligands, e.g. of an ether or alcohol,

(b) wherein in the second step the solid is separated from the suspension obtained from (a) by means of known techniques (such as centrifugation or filtration),

(c) wherein in a third step the isolated solid is optionally washed with an aqueous solution of an organic complex ligand (for example by resuspension and subsequent reisolation by filtration or centrifugation),

(d) wherein the solid obtained is subsequently dried, optionally after pulverization, at temperatures of generally 20-120° C. and at pressures of generally 0.1 mbar to standard pressure (1013 mbar),

and wherein, in the first step or immediately after the precipitation of the double metal cyanide compound (second step), one or more organic complex ligands, preferably in excess (based on the double metal cyanide compound), and optionally further complex-forming components are added.

The double metal cyanide compounds present in the DMC catalysts which can be used according to the invention are the reaction products of water-soluble metal salts and water-soluble metal cyanide salts.

For example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparing the double metal cyanide compounds preferably have a composition according to general formula (IV),

M(X)ₙ (IV)

where

M is selected from the metal cations Zn²⁺, Fe²⁺, Ni²⁺, Mn²⁺, Co²⁺, Sr²⁺, Sn²⁺, Pb²⁺, and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have a composition according to general formula (V),

Mᵣ(X)₃ (V)

where

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have a composition according to general formula (VI),

M(X)ₛ (VI)

where

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have a composition according to general formula (VII),

M(X)ₜ (VII)

where

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to general formula (VIII),

(Y)ₐM′(CN)_{b}(A)_{c} (VIII)

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and

a, b and c are integers, the values for a, b and c being selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds which are present in the DMC catalysts usable according to the invention are compounds having a compositions according to general formula (IX),

Mₓ[M′ₓ,(CN)_{y}]_{z} (IX)

in which M is defined as in formula (IV) to (VII) and

M′ is defined as in formula (IIX), and

x, x′, y and z are integers and are selected such as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in US 5 158 922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms, such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds which contain both aliphatic or cycloaliphatic ether groups and aliphatic hydroxyl groups (such as ethylene glycol mono-tert-butyl ether, diethylene glycol mono-tert-butyl ether, tripropylene glycol monomethyl ether, and 3-methyl-3-oxetanemethanol, for example). Organic complex ligands that are most preferred are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

In the preparation of the DMC catalysts that can be used in accordance with the invention, one or more complex-forming component(s) are optionally used from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxyethylcellulose and polyacetals, or of the glycidyl ethers, glycosides, carboxylic esters of polyhydric alcohols, bile acids or salts, esters or amides thereof, cyclodextrins, phosphorus compounds, α, β-unsaturated carboxylic esters, or ionic surface-active or interface-active compounds.

In the preparation of the DMC catalysts that can be used in accordance with the invention, preference is given to using the aqueous solutions of the metal salt (e.g. zinc chloride) in the first step in a stoichiometric excess (at least 50 mol %) relative to the metal cyanide salt. This corresponds at least to a molar ratio of metal salt to metal cyanide salt of 2.25:1.00. The metal cyanide salt (e.g. potassium hexacyanocobaltate) is reacted in the presence of the organic complex ligand (e.g. tert-butanol), and a suspension is formed which comprises the double metal cyanide compound (e.g. zinc hexacyanocobaltate), water, excess metal salt, and the organic complex ligand.

The organic complex ligand may be present here in the aqueous solution of the metal salt and/or the metal cyanide salt, or it is added directly to the suspension obtained after precipitation of the double metal cyanide compound. It has proven to be advantageous to mix the metal salt and metal cyanide salt aqueous solutions and the organic complex ligand with vigorous stirring. Optionally, the suspension formed in the first step is subsequently treated with a further complex-forming component. The complex-forming component is preferably used here in a mixture with water and organic complex ligand. A preferred process for performing the first step (i.e. the preparation of the suspension) is effected using a mixing nozzle, particularly preferably using a jet disperser, as described, for example, in WO-A 01/39883.

In the second step, the solid (i.e. the precursor of the catalyst of the invention) is isolated from the suspension by known techniques, such as centrifugation or filtration.

In a preferred embodiment variant, the isolated solid, in a third process step, is then washed with an aqueous solution of the organic complex ligand (for example by resuspension and subsequent reisolation by filtration or centrifugation). In this way, it is possible to remove, for example, water-soluble by-products such as potassium chloride from the catalyst of the invention. Preferably, the amount of the organic complex ligand in the aqueous wash solution is between 40% and 80% by weight, based on the overall solution.

Optionally, in the third step the aqueous wash solution is admixed with a further complex-forming component, preferably in the range between 0.5% and 5% by weight, based on the overall solution.

It is also advantageous to wash the isolated solid more than once. Preferably, in a first washing step (c-1), an aqueous solution of the unsaturated alcohol is used for washing (for example by resuspension and subsequent reisolation by filtration or centrifugation), in order in this way to remove, for example, water-soluble by-products such as potassium chloride from the catalyst of the invention. The amount of the unsaturated alcohol in the aqueous wash solution is particularly preferably between 40% and 80% by weight, based on the overall solution of the first washing step. In the further washing steps (c-2), either the first washing step is repeated one or more times, preferably one to three times, or, preferably, a nonaqueous solution, for example a mixture or solution of unsaturated alcohol and further complex-forming component (preferably in the range between 0.5% and 5% by weight, based on the total amount of the wash solution in step (c-2)), is used as a wash solution, and the solid is washed with it one or more times, preferably one to three times.

The isolated and optionally washed solid is subsequently dried, optionally after pulverization, at temperatures of 20-100° C. and at pressures of 0.1 mbar to standard pressure (1013 mbar).

One particularly preferred method for isolating the DMC catalysts of the invention from the suspension, by filtration, filtercake washing, and drying, is described in WO-A 01/80994, for example.

In a further configuration of the process for preparing the polyethercarbonate polyols, the DMC catalyst may be selected from the group comprising Mₓ[M′ₓ,(CN)_{y}]_{z} where: M=Zn(II), Fe(II), Co(II) or Ni(II); M′=Co(III), Fe(III), Cr(III) or Ir(III); and x=3, x′=1, y=6 and z=2. These DMC catalysts have proven particularly advantageous in the context of an effective process regime in the terpolymerization in terms of a high selectivity and a high conversion, even at relatively low temperatures. In particular, it is also possible to use a DMC catalyst comprising zinc hexacyanocobaltate(III).

The DMC catalyst may be used, for example, in a proportion of ≥1 ppm to ≤1000 ppm and preferably of ≥10 ppm to ≤500 ppm, based on the total mass of starter substance and epoxide used.

The use of DMC catalysts does not result in alternating polycarbonates (G. W. Coates in Macromol. 2012, 45, 7878-7883, see above), but instead in polyethercarbonates in which two or more alkylene oxides are also successively incorporated by polymerization, without incorporation of CO₂ between the monomers.

In general, a CO₂ content of 3% by weight to 35% by weight, preferably of 5% by weight to 25% by weight, is in the polyoxyalkylene polymers obtained by the process according to the invention have.

In a preferred embodiment, carbon dioxide is metered in here in its liquid or supercritical form, in order to enable optimal miscibility of the components. The carbon dioxide can be introduced in the reactor at the inlet of the reactor and/or via metering points arranged along the reactor. A portion of the alkylene oxides may be introduced at the inlet of the reactor. The remaining amount of the alkylene oxides is preferably introduced into the reactor via a plurality of metering points arranged along the reactor. Mixing elements, as for example are sold by Ehrfeld Mikrotechnik BTS GmbH, are advantageously installed for more effective mixing of the coreactants, or mixer-heat exchanger elements, which simultaneously improve mixing and heat removal. The mixing elements preferably mix metered-in CO₂ and/or alkylene oxides with the reaction mixture. In an alternative embodiment, different volume elements of the reaction mixture can be mixed with one another.

Without being tied to a theory, it is assumed that, as a result of the lower degree of regularity in the polyoxyalkylene polymer, the glass transition temperature is reduced compared to regular polycarbonate polymers. In general, a glass transition temperature T_{g} of ≥−80° C. mol to ≤−1° C., particularly ≥−70° C. mol to ≤−5° C. is in the polyoxyalkylene polymers obtained by the process according to the invention have.

The monomers used for the copolymerization with CO₂ are preferably the following epoxides of group A:

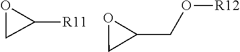

where R11 is hydrogen, a C1-C22 alkyl radical which may be substituted by chlorine, bromine or fluorine, or a vinyl radical and

R12 is a C1-C22 alkyl radical which may also contain ether bridges, a C3-C12 alkenyl radical, a C5-C12 cycloalkyl radical which may also contain ether bridges, a C6-C14 aryl radical, a heteroaryl radical, preferably a furyl radical, or a C7-C14 aralkyl or alkylaryl radical.

In a preferred embodiment, the alkylene oxide comprises one or more compound(s) selected from the group consisting of propylene oxide, ethylene oxide, 1-butylene oxide, 1-hexene oxide, 1-dodecene oxide, epichlorohydrin, methyl glycidyl ether, ethyl glycidyl ether, butyl glycidyl ether, dodecyl glycidyl ether, tetradecyl glycidyl ether, methoxyethyl glycidyl ether or methoxyethoxyethyl glycidyl ether, allyl glycidyl ether, phenyl glycidyl ether, cresyl glycidyl ether, furfuryl glycidyl ether, benzyl glycidyl ether and tetrahydrofurfuryl glycidyl ether, particularly preferably propylene oxide and ethylene oxide.

Without being bound to a theory, the epoxides of group A result in a low glass transition temperature of the copolymer obtained.

In a preferred embodiment, comonomers used for the copolymerization with CO₂ are furthermore the following epoxides of group B: styrene oxide, cyclohexene oxide, vinyl cyclohexene oxide, limonene monoxide, cyclopentene oxide or indene oxide.

Without being bound to a theory, the epoxides of group B result in an increase in the glass transition temperature of the copolymer obtained.

In a preferred embodiment, the weight ratio of the epoxides of group A used to the epoxides of group B is in the range from 100:0 to 80:20 wt. %.

It is additionally possible to use comonomers selected from one or more compound(s) from group C consisting of aliphatic lactones, aromatic lactones, lactides, cyclic carbonates having at least three optionally substituted methylene groups between the oxygen atoms of the carbonate group, aliphatic cyclic anhydrides and aromatic cyclic anhydrides. In a preferred embodiment, the comonomers of group C contain double bonds. One example of a comonomer of group C that contains a double bond is maleic anhydride used. In a preferred embodiment, the weight ratio of these comonomers to the total amount of epoxides is in the range from >0:<100 to ≥40:≤60 wt. %, particularly preferably in the range from ≥1:≤99 to ≥20:≤80 wt. %.

Embodiments and further aspects of the present invention are described hereinafter. They may be combined with one another as desired unless the opposite is clear from the context.

Preferably, the H-functional starter substance which comprises a carbon-carbon double bond is represented by the following general formula:

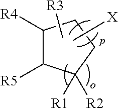

where

o is a natural number from 0 to 8 and

R1, R2, R3, R4 and R5 are each independently hydrogen, a C1-C22 alkyl radical, a C6-C14 aryl radical, a C7-C14 aralkyl or alkylaryl radical, a C5-C12 cycloalkyl radical or are an ester group —COOR6, wherein R6 is a C1-C22 alkyl radical, a C6-C14 aryl radical, a C7-C14 aralkyl or alkylaryl radical or a C5-C12 cycloalkyl radical, or the radicals R1 and R3 together form a C1-C3 alkylene bridge or an ether bridge and

p is a natural number from 1 to 6 and

X is a carboxyl group or OH group, a C1-C22 alkyl radical substituted by a carboxyl group or OH group, or a C6-C14 aryl radical substituted by a carboxyl group or OH group, or a —COOAlkOH radical, wherein AlkOH is a C2 to C12 hydroxyalkyl radical.

In a particularly preferred embodiment, the H-functional starter substance is one or more compounds are, selected from the group consisting of norbornenecarboxylic acid, hydroxyethyl norbornenecarboxylate, hydroxypropyl norbornenecarboxylate, hydroxybutyl norbornenecarboxylate, hydroxynorbornene, hydroxymethylnorbornene, cyclopentenecarboxylic acid, cyclooctenecarboxylic acid, cyclodecenecarboxylic acid, cyclopentenol and cyclooctenol.

The typical structure of the polyoxyalkylene macromers according to the invention corresponds to the following formula shown using the example of the use of propylene oxide, carbon dioxide and also norbornenecarboxylic acid as chain transfer agent/starter:

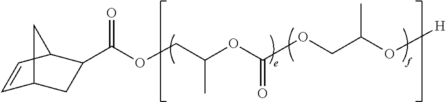

The present invention also relates to polyoxyalkylene macromers obtainable by a process according to the invention.

In general, a CO₂ content of 3% by weight to 35% by weight, preferably of 5% by weight to 25% by weight, is in the polyoxyalkylene macromers obtained by the process according to the invention have.

The ratio e:f in the polyoxyalkylene macromer obtained is generally 1:1 to 1:100, preferably 1:2 to 1:20. The sum of e+f is generally ≥3 to ≤250, preferably ≥10 to ≤100.

In the terminology of the present invention, the segments numbered with n designate the polyether repeating units and the segments numbered with m designate the polycarbonate repeating units. Polyether repeating units and polycarbonate repeating units preferably have a statistical arrangement along the polymer chain. However, there may also be gradients with a rising or falling proportion of polycarbonate repeating units or blocks of polyether repeating units and polycarbonate repeating units along the polymer chain.

In a further embodiment, one or more H-functional starter substance(s) and one or more alkylene oxide(s) are metered continuously into the reactor during the reaction. The reaction is preferably effected in the presence of carbon dioxide, with a CO₂ pressure of ≥1 bar to ≤80 bar having proven to be advantageous. The CO₂ pressure is preferably ≥5 bar to ≤60 bar, particularly preferably ≥15 bar to ≤50 bar and very particularly preferably ≥15 bar to ≤45 bar.

A further embodiment relates to the process, wherein

(α) optionally, a portion of the H-functional starter substance(s) and/or a suspension medium containing no H-functional groups is initially charged in a reactor, in each case optionally together with DMC catalyst,

(β) optionally, a portion of alkylene oxide is added to the mixture from step (α) at temperatures of 90 to 150° C., and the addition of the alkylene oxide compound then being halted, and

(γ) one or more H-functional starter substance(s) are metered continuously into the reactor during the reaction.

Preferably, in step (γ), DMC catalyst is additionally metered continuously into the reactor and the resulting reaction mixture is removed continuously from the reactor.

It is also possible that:

(δ) the reaction mixture which is removed continuously in step (γ) and has a content of 0.05% by weight to 10% by weight of alkylene oxide is transferred into a postreactor in which the free alkylene oxide content is reduced to less than 0.05% by weight in the reaction mixture by way of postreaction.

In a further embodiment of the process according to the invention, at least 80% by weight, preferably 100% by weight, (based on the total amount of alkylene oxides used) of the alkylene oxides are selected from the group of compounds having the following general formulae:

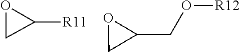

where R11 is hydrogen, a C₁-C₂₂ alkyl radical which may be substituted by chlorine, bromine or fluorine, or a vinyl radical, preferably is hydrogen or methyl, and

R12 is a C₁-C₂₂ alkyl radical which may also contain ether bridges, a C₃-C₁₂ alkenyl radical, preferably an allyl radical, a C₅-C₁₂ cycloalkyl radical which may also contain ether bridges, a C₆-C₁₄ aryl radical, a heteroaryl radical, preferably a furyl radical, or a C₇-C₁₄ aralkyl or alkylaryl radical.

In a further embodiment of the process according to the invention, said process further comprises the step of reacting the polyoxyalkylene macromer obtained with an acid anhydride or a protective group reagent.

Reaction with a protective group reagent allows the OH group to be capped prior to performing the ROMP, wherein examples of protective group reagents that can be used include bistrimethylsilylacetamide, bistrimethylsilylurea, hexamethyldisilazane in a mixture with trichloromethylsilane, diazomethane, BOC anhydride, acetic anhydride, trifluoroacetic anhydride, phenyl isocyanate, methyl isocyanate, ethyl isocyanate, butyl isocyanate, hexyl isocyanate or cyclohexyl isocyanate, and, in a mixture with equimolar amounts of bases, tosyl chloride, mesyl chloride, trifluoromethanesulfonyl chloride, benzyl chloroformate, o-nitrobenzyl chloroformate, benzyl chloride, o-nitrobenzyl chloride, benzhydryl chloride, trityl chloride, diphenylphosphoryl chloride, methyl iodide or trimethylchlorosilane.

Some of these protective groups can be removed again after performing the ROMP, without breakdown of the brush polymer occurring. Examples are protective groups which can be detached by hydrogenation, such as for example the benzyl, benzyl carbonate or benzhydryl protective group, or protective groups that can be detached by protic compounds such as water or methanol even within the pH range of 4 to 8, such as for example the trimethylsilyl protective group.

In addition, the OH group prior to performing the ROMP can be converted into an acid group with cyclic anhydrides, with formation of the half-ester.

Examples of cyclic anhydrides are succinic anhydride, hexylsuccinic anhydride, octylsuccinic anhydride, dodecenylsuccinic anhydride, glutaric anhydride, cyclohexanedicarboxylic anhydride, 4-methylcyclohexanedicarboxylic anhydride, tetrahydrophthalic anhydride, 4-methyltetrahydrophthalic anhydride, phthalic anhydride, trimellitic anhydride, tetrachlorophthalic anhydride, tetrabromophthalic anhydride, nitrophthalic anhydride, diphenic anhydride.

In the exemplary reaction of a polyoxyalkylene macromer, obtained by reacting propylene oxide, carbon dioxide and also norbornenecarboxylic acid as chain transfer agent/starter with cyclohexanedicarboxylic anhydride, a polyoxyalkylene macromer of the following formula is formed:

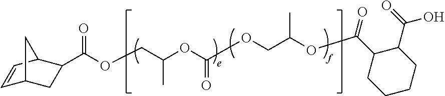

The present invention also relates to polyoxyalkylene macromers obtainable by a process according to the invention.

In general, a CO₂ content of 3% by weight to 35% by weight, preferably of 5% by weight to 25% by weight, is in the polyoxyalkylene macromers obtained by the process according to the invention have, wherein the CO₂ content has been determined by means of ¹H NMR.

In a preferred embodiment, the polyoxyalkylene macromers have a number-average molecular weight Mn of ≥500 g/mol to ≤1 000 000 g/mol, particularly preferably ≥1000 g/mol to ≤200 000 g/mol, which has been determined by means of GPC.

Preferably, the polyoxyalkylene macromers according to the invention have a glass transition temperature Tg of ≥−80° C. mol to ≤−1° C., particularly ≥−70° C. mol to ≤−5° C., measured in accordance with DSC method according to ISO 6721-11 at a heating rate of 10 K/min.

The present invention further provides a process for preparing polyoxyalkylene brush polymers, wherein the process comprises the step of reacting an aforementioned polyoxyalkylene macromer according to the invention with an olefin metathesis catalyst.

For the purposes of the invention, “brush polymers” are understood to mean graft polymers which are obtainable by polymerization of monofunctional macromers or copolymerization of monofunctional macromers with comonomers. A structure results in which polymer grafts are attached to a polymer backbone only on one side. Brush polymers are typically graft polymers having a high grafting density.

The olefin metathesis catalysts used for the ring-opening olefin metathesis reaction (ROMP) are preferably molybdenum or tungsten carbenes (Schrock carbenes) or ruthenium carbenes (Grubbs catalysts). Suitable ruthenium carbenes are described in Polymer 50(2010) 2947-2946 and the literature cited therein. Preferably, the olefin metathesis catalyst is one or more ruthenium carbene complex(es) and are selected from the group consisting of dichloro[1,3-bis(2,4,6-trimethylphenyl)-2-imidazolidinylidene](benzylidene)bis(3-bromopyridine)ruthenium(II), dichloro[1,3-bis(2,4,6-trimethylphenyl)-2-imidazolidinylidene](2-isopropoxyphenylmethylene)ruthenium(II), dichloro(benzylidene)bis(tricyclohexylphosphine)ruthenium(II) and dichloro[1,3-bis(2-methylphenyl)-2-imidazolidinylidene](2-isopropoxyphenylmethylene)ruthenium(II).

It is further preferred for the reaction to be additionally conducted in the presence of a cyclic olefin.

These cyclic olefins can also be incorporated into the crosslinked polymer by polymerization and in this way make it possible for the individual polyoxyalkylene segments to keep a larger spacing from one another.

They correspond to the following formula

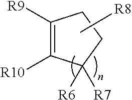

wherein R7, R8, R9, R10 and R11 are hydrogen, a C1-C22 alkyl radical, a C6-C14 aryl radical, a C7-C14 aralkyl or alkylaryl radical, a C5-C12 cycloalkyl radical or are an ester group —COOR6, wherein R6 is a C1-C22 alkyl radical, a C6-C14 aryl radical, a C7-C14 aralkyl or alkylaryl radical or a C5-C12 cycloalkyl radical, or the radicals R1 and R3 together form a C1-C3 alkylene bridge or an ether bridge.

Examples of suitable ROMP-capable cyclic olefins are norbornene, dimethyl norbornenedicarboxylate, diethyl norbornenedicarboxylate, dibutyl norbornenedicarboxylate, methyl norbornenecarboxylate, ethyl norbornenedicarboxylate, butyl norbornenecarboxylate, cyclopentene or cyclooctene.

The ratio between cyclic olefin and polyoxyalkylene macromer p:o can vary within wide ranges.

The ratio p:o is preferably ≥0 to ≤10, the sum of p+o is preferably ≥10 to ≤500.

It is further preferred for the polyoxyalkylene brush polymer obtained to be reacted with an acid anhydride or a protective group reagent. The acid anhydride or protective group reagent used can be the above-mentioned compounds.

Also included within the present invention are polyoxyalkylene brush polymers obtainable by the above process. A polyoxyalkylene brush polymer corresponds, by way of example, to the following formula if the polyoxyalkylene macromer used was an above-mentioned polyoxyalkylene macromer and the cyclic olefin used was norbornene.

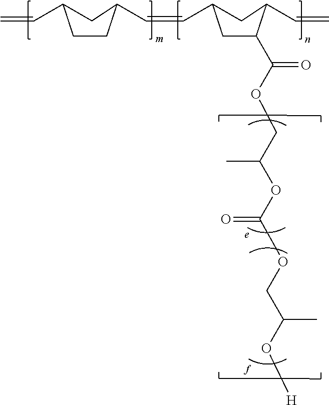

Polyoxyalkylene brush polymers can subsequently be reacted with cyclic acid anhydrides, with formation of the half-ester, to give acid-functional polyoxyalkylene brush polymers. The ratio p:o is preferably 0 to 10, the sum of p+o is preferably 10 to 500.

Preferably, the polyoxyalkylene brush polymers according to the invention have a glass transition temperature, measured in accordance with DSC method according to ISO 6721-11 at a heating rate of 10 K/min, of ≥−80° C. mol to ≤−1° C., particularly ≥−70° C. mol to ≤−5° C.

The brush polymers obtained according to the invention can be crosslinked to give elastomers using free-radical initiators, such as cumyl peroxide, t-butyl peroxide or Trigonox 101, optionally in the presence of other co-crosslinkers containing double bonds such as methacrylates of ethylene glycol or of trimethylolpropane, triallyl isocyanurate, triallyl cyanurate or bismaleimides of MDA or of TDA.

If the brush polymers have unprotected OH groups, they can be crosslinked by means of di- or polyfunctional isocyanates, MF resins or UF resins.

If the brush polymers have acid groups that were introduced by reaction of the OH groups with cyclic anhydrides, they may be crosslinked with epoxy resins.

Therefore, the invention further provides crosslinked polyoxyalkylene polymers obtainable by:
reaction of OH end group-comprising polyoxyalkylene brush polymers according to the invention with polyisocyanates;
or
reaction of OH end group-comprising polyoxyalkylene brush polymers according to the invention with with polycarboxylic acids or cyclic carboxylic anhydrides;
or
free-radical crosslinking of polyoxyalkylene brush polymers according to the invention.

Preferably, the crosslinked polyoxyalkylene polymers have a glass transition temperature, measured in accordance with DSC method according to ISO 6721-11 at a heating rate of 10 K/min, of ≤0° C.

The invention is elucidated further by means of the examples which follow, but without being limited thereto.

### EXAMPLES

### Feedstocks

### H-Functional Starter Substances

NCA: 5-norbornene-2-carboxylic acid (Sigma-Aldrich, 98%)

### Epoxides

propylene oxide (Chemogas NV, 99.9%)

### Comonomer

norbornene (Sigma-Aldrich, 99%)

### Suspension Medium

cPC: cyclic propylene carbonate (Sigma-Aldrich, 99%)

### Catalyst

The DMC catalyst used in all examples was DMC catalyst prepared according to example 6 in WO 01/80994 A1.

Grubbs catalyst: dichloro[1,3-bis(2,4,6-trimethylphenyl)-2-imidazolidinylidene](benzylidene)bis(3-bromopyridine)ruthenium(II) (Sigma-Aldrich)

### Methods

The polymerization reactions were conducted in a 300 ml Parr pressure reactor. The pressure reactor used in the examples had a height (internal) of 10.16 cm and an internal diameter of 6.35 cm. The reactor was equipped with an electric heating jacket (510 watts' maximum heating power). The counter-cooling consisted of an immersed tube of external diameter 6 mm which had been bent into a U shape and which projected into the reactor up to 5 mm above the base, and through which flowed cooling water of about 10° C. The water flow was switched on and off by means of a solenoid valve. In addition, the reactor was equipped with an inlet tube and a thermal sensor of diameter 1.6 mm, which both projected into the reactor up to 3 mm above the base.

The sparging stirrer used in the examples was a hollow shaft stirrer in which the gas was introduced into the reaction mixture via a hollow shaft in the stirrer. The stirrer body attached to the hollow shaft comprised four arms, had a diameter of 35 mm and a height of 14 mm. Each arm end had two gas outlets of diameter 3 mm attached to it. The rotation of the stirrer gave rise to a reduced pressure such that the gas present above the reaction mixture (CO₂ and possibly alkylene oxide) was drawn off and introduced through the hollow shaft of the stirrer into the reaction mixture. The abbreviation rpm refers to the number of revolutions of the stirrer per minute.

Subsequently, the reaction mixture was diluted with dichloromethane (20 ml) and the solution was passed through a falling-film evaporator. The solution (0.1 kg in 3 h) ran downwards along the inner wall of a tube of diameter 70 mm and length 200 mm which had been heated externally to 120° C., in the course of which the reaction mixture was distributed homogeneously as a thin film on the inner wall of the falling-film evaporator in each case by three rollers of diameter 10 mm rotating at a speed of 250 rpm. Within the tube, a pump was used to set a pressure of 3 mbar. The reaction mixture which had been purified to free it of volatile constituents (unconverted epoxides, cyclic carbonate, solvent) was collected in a receiver at the lower end of the heated tube.

a) The copolymerization of propylene oxide and CO₂ not only resulted in the cyclic propylene carbonate but also in the polyethercarbonate macromer which firstly contains polycarbonate units shown in the following formula:

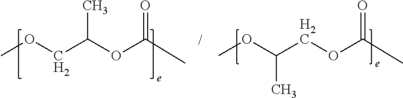

and secondly contains polyether units shown in the following formula:

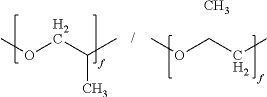

For ¹H NMR spectra, the sample was dissolved in deuterated chloroform and analyzed on a Bruker spectrometer (AV400, 400 MHz).

The relevant resonances in the ¹H NMR spectrum (based on TMS=0 ppm) which were used for integration are as follows:

I1: 1.10-1.17 ppm: CH₃ group of the polyether units, area of the resonance corresponds to three hydrogen atoms,

I2: 1.25-1.34 ppm: CH₃ group of the polycarbonate units, area of the resonance corresponds to three hydrogen atoms,

I3: 6.22-6.29 ppm: CH group of the double bond obtained in the polymer via the incorporation of 5-norbornene-2-carboxylic acid, area of the resonance corresponds to two hydrogen atoms.

Data reported are the molar ratio of carbonate groups to ether groups in the polyethercarbonate macromer (e/f), the proportion of carbonate groups (mol %) in the polyethercarbonate macromer, the proportion of ether groups (mol %) in the polyethercarbonate macromer, the proportion of NCA (mol %) in the polyethercarbonate macromer and also the proportion of CO₂ (% by weight) in the polyethercarbonate macromer.

Molar ratio of carbonate groups to ether groups in the polyethercarbonate macromer (e/f):

e/f=I2/I1

The proportion of carbonate groups (mol %) in the polyethercarbonate macromer:

$$carbonate group incorporation ( mol \% ) = [ \frac{( \frac{l 2}{3} )}{( \frac{l 1}{3} ) + ( \frac{l 2}{3} ) + ( \frac{l 3}{2} )} ] * 100$$

The proportion of ether groups (mol %) in the polyethercarbonate macromer:

$$ether group incorporation ( mol \% ) = [ \frac{( \frac{l 2}{3} )}{( \frac{l 1}{3} ) + ( \frac{l 2}{3} ) + ( \frac{l 3}{2} )} ] * 100$$

The proportion of NCA (mol %) in the polyethercarbonate macromer:

$$NCA incorporation ( mol \% ) = [ \frac{( \frac{l 2}{3} )}{( \frac{l 1}{3} ) + ( \frac{l 2}{3} ) + ( \frac{l 3}{2} )} ] * 100$$

The proportion of CO₂ incorporation (% by weight) in the polyethercarbonate macromer:

$${CO}_{2} incorporation ( \% by wieght ) = [ \frac{( \frac{l 2}{3} ) * 44}{( \frac{l 1}{3} * 58 ) + ( \frac{l 2}{3} * 102 ) + ( \frac{l 3}{2} * 138 )} ] * 100$$

### OH Number (Hydroxyl Number)

The OH number (hydroxyl number) was determined on the basis of DIN 53240-2, except N-methylpyrrolidone rather than THF/dichloromethane was used as the solvent. Titration was effected with 0.5 molar ethanolic KOH solution, with endpoint recognition by means of potentiometry. The test substance used was certified castor oil. The reporting of the unit in “mg KOH/g” relates to mg[KOH]/g[polyethercarbonate macromer].

### Gel Permeation Chromatography

The number-average Mₙ and the weight-average M_{w} molecular weights of the polyethercarbonate polyols obtained were determined by means of gel permeation chromatography (GPC). The procedure was that of DIN 55672-1: “Gel permeation chromatography, Part 1—Tetrahydrofuran as eluent” (SECurity GPC system from PSS Polymer Service, flow rate 1.0 ml/min; columns: 2×PSS SDV linear M, 8×300 mm, 5 μm; RID detector). Polystyrene samples of known molar mass were used for calibration. The polydispersity was calculated as the ratio M_{w}/Mₙ.

### Rheology

The viscosity of the product mixture was determined using a Physica MCR 501 rheometer from Anton Paar at 25° C., using a sphere/plate configuration with a sphere diameter of 25 mm and with a distance of 0.05 mm between sphere and plate. The shear rate was increased from 0.01 to 1000 1/s within 10 minutes. A value was taken every 10 s. The result reported is the viscosity as the average of the total of 60 measurement values.

### Thermal Analysis

The glass transition temperature was measured using a Mettler Toledo DSC 1. Between 4 and 10 mg of the sample to be measured were heated from −80° C. to 40° C. at a heating rate of 10 K/min. The evaluation software used was STAR^{e} 25 SW 11.00. For the determination of the glass transition temperature, a tangential evaluation method was applied unless otherwise stated. The glass transition temperature reported is the mid-point between the point of intersection of the middle tangent with the low-temperature tangent and the point of intersection of the middle tangent with the high-temperature tangent.

### Example 1: Preparation of a Polyethercarbonate Macromer by Copolymerization in the Semi-Batch CAOS Process at 15 bar of CO₂

### Step α

A 300 ml pressure reactor equipped with a sparging stirrer was initially charged with a mixture of DMC catalyst (21.5 mg) and cyclic propylene carbonate (30 g) and this initial charge was stirred (800 rpm) at 110° C. for 30 minutes under a partial vacuum (50 mbar), with argon being passed through the reaction mixture.

### Step β

The suspension was then heated up to 130° C. and CO₂ was injected to 15 bar, in the course of which a slight drop in temperature was observed. On reattainment of a temperature of 130° C., 1.5 g of propylene oxide were metered in with the aid of an HPLC pump (1 ml/min). The reaction mixture was stirred (800 rpm) at 130° C. for 20 min. The addition of 1.5 g of the monomer mixture was repeated a second and third time.

### Step γ

The temperature was readjusted to 110° C. and, during the subsequent steps, the pressure in the pressure reactor was kept at 15 bar with the aid of a mass flow regulator by metering in further CO₂. While stirring, a further 15.5 g of a propylene oxide were metered in by means of an HPLC pump (1 ml/min), while continuing to stir the reaction mixture (800 rpm). Three minutes after the start of addition of propylene oxide, 2.12 g of 5-norbornene-2-carboxylic acid were metered in by means of a separate HPLC pump (0.16 ml/min) while stirring. After the addition of propylene oxide had ended, the reaction mixture was stirred at 110° C. for a further 30 min. The reaction was ended by cooling the pressure reactor in an ice bath, and the elevated pressure was released.

The reaction mixture diluted with dichloromethane (20 ml), the solution passed through a falling-film evaporator and the resulting product analyzed. The proportion of carbonate groups (mol %), ether groups (mol %), NCA groups (mol %) and CO₂ (% by weight) incorporated in the polyethercarbonate macromer obtained, the ratio of carbonate units to ether units, the molecular weight obtained, the polydispersity index (PDI), the glass transition temperature (T_{g}) and the decomposition temperature (T_{D}) are reported in table 1.

### Example 2: Preparation of a Polyethercarbonate Macromer by Copolymerization in the Semi-Batch CAOS Process at 15 Bar of CO₂

### Step α

A 300 ml pressure reactor equipped with a sparging stirrer was initially charged with a mixture of DMC catalyst (21.5 mg) and cyclic propylene carbonate (30 g) and this initial charge was stirred (800 rpm) at 110° C. for 30 minutes under a partial vacuum (50 mbar), with argon being passed through the reaction mixture.

### Step β

The suspension was then heated up to 130° C. and CO₂ was injected to 15 bar, in the course of which a slight drop in temperature was observed. On reattainment of a temperature of 130° C., 2.0 g of propylene oxide were metered in with the aid of an HPLC pump (1 ml/min). The reaction mixture was stirred (800 rpm) at 130° C. for 20 min. The addition of 2.0 g of the monomer mixture was repeated a second and third time.

### Step γ

The temperature was readjusted to 110° C. and, during the subsequent steps, the pressure in the pressure reactor was kept at 15 bar with the aid of a mass flow regulator by metering in further CO₂. While stirring, a further 41.2 g of a propylene oxide were metered in by means of an HPLC pump (1 ml/min), while continuing to stir the reaction mixture (800 rpm). Three minutes after the start of addition of propylene oxide, 2.74 g of 5-norbornene-2-carboxylic acid were metered in by means of a separate HPLC pump (0.08 ml/min) while stirring. After the addition of propylene oxide had ended, the reaction mixture was stirred at 110° C. for a further 30 min. The reaction was ended by cooling the pressure reactor in an ice bath, and the elevated pressure was released.

The reaction mixture diluted with dichloromethane (20 ml), the solution passed through a falling-film evaporator and the resulting product analyzed. The proportion of carbonate groups (mol %), ether groups (mol %), NCA groups (mol %) and CO₂ (% by weight) incorporated in the polyethercarbonate macromer obtained, the ratio of carbonate units to ether units, the molecular weight obtained, the polydispersity index (PDI), the glass transition temperature (T_{g}) and the decomposition temperature (T_{D}) are reported in table 1.

### Comparative Example 3: Preparation of a Polyethercarbonate Macromer by Copolymerization in the Semi-Batch Process at 15 Bar of CO₂

The procedure was as described in example 1, with 5-norbornene-2-carboxylic acid (2.74 g) being initially charged in step α. No polyethercarbonate macromer was obtained.

### Comparison

Table 1 below shows a comparison of the results obtained for continuous metering of the starter (Continuous Addition Of Starter, CAOS, examples 1 to 3) compared to metering of the starter in batch mode (comparative example 4).

TABLE 1

| | | Carbonate | Ether | NCA | CO₂ | | | | | |
|---|---|---|---|---|---|---|---|---|---|---|
| | Metering | groups | groups | groups | content | e/f | Mₙ | PDI | T_{g} | T_{D} |
| Example | of starter | [mol %] | [mol %] | [mol %] | [% by wt.] | [—] | [g/mol] | [—] | [° C.] | [° C.] |
| 1 | CAOS | 15.6 | 81.9 | 2.6 | 10.4 | 0.19 | 1488 | 1.3 | −60.3 | 320.5 |
| 2 | CAOS | 15.9 | 81.9 | 2.3 | 10.6 | 0.19 | 2693 | 2.9 | −55.6 | 322.8 |

| | | |
|---|---|---|
| 3 (comp.) | Batch | No polymer formation |

(comp.): Comparative example

Table 1 shows that no polymer formation takes place in the case where the starter is initially charged at the start of the reaction (comparative example 4). The metering of the starter in the CAOS process is therefore essential for the preparation of polyethercarbonate macromers when using acid-functional starters.

### Example 4: Preparation of a Polyethercarbonate Macromer by Copolymerization in the Semi-Batch CAOS Process at 50 Bar of CO₂

### Step α

A 300 ml pressure reactor equipped with a sparging stirrer was initially charged with a mixture of DMC catalyst (21.5 mg) and cyclic propylene carbonate (30 g) and this initial charge was stirred (800 rpm) at 110° C. for 30 minutes under a partial vacuum (50 mbar), with argon being passed through the reaction mixture.

### Step β

The suspension was then heated up to 130° C. and CO₂ was injected to 15 bar, in the course of which a slight drop in temperature was observed. On reattainment of a temperature of 130° C., 2.0 g of propylene oxide were metered in with the aid of an HPLC pump (1 ml/min). The reaction mixture was stirred (800 rpm) at 130° C. for 20 min. The addition of 2.0 g of the monomer mixture was repeated a second and third time.

### Step γ

The temperature was readjusted to 110° C. and, during the subsequent steps, the pressure in the pressure reactor was kept at 15 bar with the aid of a mass flow regulator by metering in further CO₂. While stirring, a further 21.0 g of a propylene oxide were metered in by means of an HPLC pump (1 ml/min), while continuing to stir the reaction mixture (800 rpm). Three minutes after the start of addition of propylene oxide, 2.74 g of 5-norbornene-2-carboxylic acid were metered in by means of a separate HPLC pump (0.11 ml/min) while stirring. After the addition of propylene oxide had ended, the reaction mixture was stirred at 110° C. for a further 30 min. The reaction was ended by cooling the pressure reactor in an ice bath, and the elevated pressure was released.

The reaction mixture diluted with dichloromethane (20 ml), the solution passed through a falling-film evaporator and the resulting product analyzed. The proportion of carbonate groups (mol %), ether groups (mol %), NCA groups (mol %) and CO₂ (% by weight) incorporated in the polyethercarbonate macromer obtained, the ratio of carbonate units to ether units, the molecular weight obtained, the polydispersity index (PDI), the glass transition temperature (T_{g}) and the decomposition temperature (T_{D}) are reported in table 2.

### Example 5: Preparation of a Polyethercarbonate Macromer by Copolymerization in the Semi-Batch CAOS Process at 50 Bar of CO₂

### Step α

A 300 ml pressure reactor equipped with a sparging stirrer was initially charged with a mixture of DMC catalyst (21.5 mg) and cyclic propylene carbonate (30 g) and this initial charge was stirred (800 rpm) at 110° C. for 30 minutes under a partial vacuum (50 mbar), with argon being passed through the reaction mixture.

### Step β

The suspension was then heated up to 130° C. and CO₂ was injected to 15 bar, in the course of which a slight drop in temperature was observed. On reattainment of a temperature of 130° C., 2.0 g of propylene oxide were metered in with the aid of an HPLC pump (1 ml/min). The reaction mixture was stirred (800 rpm) at 130° C. for 20 min. The addition of 2.0 g of the monomer mixture was repeated a second and third time.

### Step γ

The temperature was readjusted to 110° C. and, during the subsequent steps, the pressure in the pressure reactor was kept at 15 bar with the aid of a mass flow regulator by metering in further CO₂. While stirring, a further 28.2 g of a propylene oxide were metered in by means of an HPLC pump (1 ml/min), while continuing to stir the reaction mixture (800 rpm). Three minutes after the start of addition of propylene oxide, 2.0 g of 5-norbornene-2-carboxylic acid were metered in by means of a separate HPLC pump (0.08 ml/min) while stirring. After the addition of propylene oxide had ended, the reaction mixture was stirred at 110° C. for a further 30 min. The reaction was ended by cooling the pressure reactor in an ice bath, and the elevated pressure was released.

The reaction mixture diluted with dichloromethane (20 ml), the solution passed through a falling-film evaporator and the resulting product analyzed. The proportion of carbonate groups (mol %), ether groups (mol %), NCA groups (mol %) and CO₂ (% by weight) incorporated in the polyethercarbonate macromer obtained, the ratio of carbonate units to ether units, the molecular weight obtained, the polydispersity index (PDI), the glass transition temperature (T_{g}) and the decomposition temperature (T_{D}) are reported in table 2.

### Comparative Example 6: Preparation of a Polyethercarbonate Macromer by Copolymerization in the Semi-Batch Process at 50 Bar of CO₂

The procedure was as described in example 5, with 5-norbornene-2-carboxylic acid (2.74 g) being initially charged in step α. No polyoxyalkylene polyol macromer was obtained.

### Comparison

Table 2 below shows a comparison of the results obtained for continuous metering of the starter (Continuous Addition Of Starter, CAOS, examples 5 and 6) compared to metering of the starter in batch mode (comparative example 6).

TABLE 2

| | | Carbonate | Ether | NCA | CO₂ | | | | | |
|---|---|---|---|---|---|---|---|---|---|---|
| | Metering | groups | groups | groups | content | e/f | Mₙ | PDI | T_{g} | T_{D} |
| Example | of starter | [mol %] | [mol %] | [mol %] | [% by wt.] | [—] | [g/mol] | [—] | [° C.] | [° C.] |
| 4 | CAOS | 28.2 | 68.5 | 3.3 | 17.3 | 0.41 | 1879 | 2.3 | −45.8 | 309.7 |
| 5 | CAOS | 29.0 | 69.5 | 1.5 | 17.9 | 0.42 | 4072 | 2.1 | −44.2 | 309.7 |

| | | |
|---|---|---|
| 6 (comp.) | Batch | No polymer formation |

(comp.): Comparative example

Table 2 shows that no polymer formation takes place in the case where the starter is initially charged at the start of the reaction. The metering of the starter in the CAOS process is therefore essential for the preparation of polyethercarbonate macromers when using acid-functional starters.

The comparison of the results from table 1 with the results from table 2 shows that at a higher CO₂ partial pressure more CO₂ is incorporated into the polyoxyalkylene polyol macromer.

### Example 7: Preparation of a Polyethercarbonate Brush Polymer

In a 50 ml flask, the polyethercarbonate macromer from example 1 (404.5 mg, 172.2 μmol, 1.0 eq.) was dissolved in dichloromethane (1 ml) and stirred for 15 minutes. Subsequently, a solution of third-generation Grubbs catalyst (3.8 mg, 4.3 μmol, 2.3 mol %) in dichloromethane (1 ml) was added. The reaction mixture was stirred at room temperature for 60 min. The reaction was then ended by adding ethyl vinyl ether (0.5 ml, 5.3 μmol). Next, the solvent was removed under reduced pressure and the product was analyzed. The molecular weight obtained, the polydispersity index (PDI), glass transition temperature (T_{g}) are reported in table 3.

### Example 8: Preparation of a Polyethercarbonate Brush Polymer

In a 50 ml flask, the polyethercarbonate macromer from example 2 (397.5 mg, 175.3 μmol, 1.0 eq.) was dissolved in dichloromethane (1 ml) and stirred for 15 minutes. Subsequently, a solution of third-generation Grubbs catalyst (3.6 mg, 4.1 μmol, 2.3 mol %) in dichloromethane (1 ml) was transferred. The reaction mixture was stirred at room temperature for 60 min. The reaction was then ended with the addition of ethyl vinyl ether (0.5 ml, 5.3 μmol). Next, the solvent was removed under reduced pressure and the product was analyzed. The molecular weight obtained, the polydispersity index (PDI), glass transition temperature (T_{g}) are reported in table 3.

### Example 9: Preparation of a Polyethercarbonate Brush Polymer

In a 50 ml flask, the polyethercarbonate macromer from example 5 (401.1 mg, 213.5 μmol, 1.0 eq.) was dissolved in dichloromethane (1 ml) and stirred for 15 minutes. Subsequently, a solution of third-generation Grubbs catalyst (3.7 mg, 4.2 μmol, 2.3 mol %) in dichloromethane (1 ml) was added. The reaction mixture was stirred at room temperature for 60 min. The reaction was then ended by adding ethyl vinyl ether (0.5 ml, 5.3 μmol). Next, the solvent was removed under reduced pressure and the product was analyzed. The molecular weight obtained, the polydispersity index (PDI), glass transition temperature (T_{g}) are reported in table 4.

### Example 10: Preparation of a Polyethercarbonate Brush Polymer

In a 50 ml flask, the polyethercarbonate macromer from example 6 (401.2 mg, 98.5 μmol, 1.0 eq.) was dissolved in dichloromethane (1 ml) and stirred for 15 minutes. Subsequently, a solution of third-generation Grubbs catalyst (3.7 mg, 4.2 μmol, 2.3 mol %) in dichloromethane (1 ml) was added. The reaction mixture was stirred at room temperature for 60 min. The reaction was then ended by adding ethyl vinyl ether (0.5 ml, 5.3 μmol). Next, the solvent was removed under reduced pressure and the product was analyzed. The molecular weight obtained, the polydispersity index (PDI), glass transition temperature (T_{g}) are reported in table 4.

TABLE 3

| | Mₙ | PDI | T_{g} | T_{D} |
|---|---|---|---|---|
| Example | [g/mol] | [—] | [° C.] | [° C.] |
| 7 | 92 904 | 1.2 | −59.3 | 317.3 |
| 8 | 99 231 | 1.2 | −56.8 | 327.2 |
| 9 | 105 500 | 1.2 | −40.4 | 313.1 |
| 10 | 98 530 | 1.1 | −42.9 | 311.5 |

The results from table 4 show that the glass transition temperature T_{g} of the polyethercarbonate brush polymers (examples 7, 8, 9 and 10) is only insignificantly increased compared to the corresponding polyethercarbonate macromers (examples 1, 2, 4 and 5), although the molar mass has been increased by more than a power of ten. As a result, the high molecular weight polyethercarbonate brush polymers according to the invention can be used particularly effectively for rubber applications.

### Example 11: Preparation of a Polyethercarbonate Brush Polymer at a Ratio of Polyethercarbonate Macromer to Cyclic Olefin of 95:5

In a 50 ml flask, the polyethercarbonate macromer from example 5 (401.2 mg, 213.5 μmol, 1.0 eq.) and norbornene (20.4 mg, 216.7 μmol, 1.0 eq.) were dissolved in dichloromethane (1 ml) and stirred for 15 minutes. Subsequently, a solution of third-generation Grubbs catalyst (3.8 mg, 4.2 μmol, 2.0 mol %) in dichloromethane (1 ml) was transferred. The reaction mixture was stirred at room temperature for 60 min. The reaction was then ended with the addition of ethyl vinyl ether (1 ml, 10.4 μmol). Next, the solvent was removed under reduced pressure and the product was analyzed. The molecular weight obtained, the polydispersity index (PDI), glass transition temperature (T_{g}) are reported in table 5.

### Example 12: Preparation of a Polyethercarbonate Brush Polymer at a Ratio of Polyethercarbonate Macromer to Cyclic Olefin of 80:20

In a 50 ml flask, the polyethercarbonate macromer from example 5 (388.6 mg, 214.5 μmol, 1.0 eq.) and norbornene (96.9 mg, 1029.2 μmol, 5 eq.) were dissolved in dichloromethane (1 ml) and stirred for 15 minutes. Subsequently, a solution of third-generation Grubbs catalyst (4.2 mg, 4.6 μmol, 2.0 mol %) in dichloromethane (1 ml) was transferred. The reaction mixture was stirred at room temperature for 60 min. The reaction was then ended with the addition of ethyl vinyl ether (1 ml, 10.4 μmol). Next, the solvent was removed under reduced pressure and the product was analyzed. The molecular weight obtained, the polydispersity index (PDI), glass transition temperature (T_{g}) are reported in table 5.

### Example 13: Preparation of a Polyethercarbonate Brush Polymer at a Ratio of Polyethercarbonate Macromer to Cyclic Olefin of 67:33

In a 50 ml flask, the polyethercarbonate macromer from example 5 (403.1 mg, 214.5 μmol, 1.0 eq.) and norbornene (202.0 mg, 2145.5 μmol, 10 eq.) were dissolved in dichloromethane (1 ml) and stirred for 15 minutes. Subsequently, a solution of third-generation Grubbs catalyst (5.5 mg, 6.02 μmol, 2.0 mol %) in dichloromethane (1 ml) was transferred. The reaction mixture was stirred at room temperature for 60 min. The reaction was then ended with the addition of ethyl vinyl ether (1 ml, 10.4 μmol). Next, the solvent was removed under reduced pressure and the product was analyzed. The molecular weight obtained, the polydispersity index (PDI), glass transition temperature (T_{g}) are reported in table 5.

TABLE 4

| | Monomers used | | | | | |
|---|---|---|---|---|---|---|
| | PEC-M | Norbornene | Mₙ | PDI | T_{g} | T_{D} |
| Example | [% by wt.] | [% by wt.] | [g/mol] | [—] | [° C.] | [° C.] |
| 10 | 100 | 0 | 105 500 | 1.2 | −40.4 | 313.1 |
| 11 | 95 | 5 | 91 352 | 1.2 | −40.0 | 314.0 |
| 12 | 80 | 20 | 101 140 | 1.2 | −37.0 | 311.0 |
| 13 | 67 | 33 | 123 070 | 1.2 | −35.0 | 312.0 |

PEC-M: Polyethercarbonate macromer
Comp.: Comparative example

1. A process for preparing polyoxyalkylene macromers, comprising reacting one or more H-functional starter substances and one or more alkylene oxides in the presence of a catalyst,
wherein
at least one of the H-functional starter substances comprises a carbon-carbon double bond which is part of a cyclic structure, and
wherein the starter substance and the alkylene oxide are metered continuously into the reactor during the reaction.

2. The process as claimed in claim 1, wherein the H-functional starter substance which comprises a carbon-carbon double bond corresponds to the following general formula: 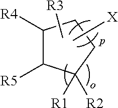
wherein
o represents a natural number from 0 to 8,
R1, R2, R3, R4 and R5 each independently represent hydrogen, a C1-C22 alkyl radical, a C6-C14 aryl radical, a C7-C14 aralkyl radical, a C7-C14 alkylaryl radical, a C5-C12 cycloalkyl radical, or are an ester group —COOR6, wherein R6 represents a C1-C22 alkyl radical, a C6-C14 aryl radical, a C7-C14 aralkyl radical, a C7-C14 alkylaryl radical, a C5-C12 cycloalkyl radical, or the radicals R1 and R3 together form a C1-C3 alkylene bridge or an ether bridge,
p represents a natural number from 1 to 6, and
X represents a carboxyl group, an OH group, a C1-C22 alkyl radical substituted by a carboxyl group or OH group, a C6-C14 aryl radical substituted by a carboxyl group or OH group, or a —COOAlkOH radical, wherein AlkOH represents a C2 to C12 hydroxyalkyl radical.

3. The process as claimed in claim 1, wherein the H-functional starter substance comprises norbornenecarboxylic acid, hydroxyethyl norbornenecarboxylate, hydroxypropyl norbornenecarboxylate, hydroxybutyl norbornenecarboxylate, hydroxynorbornene, hydroxymethylnorbornene, cyclopentenecarboxylic acid, cyclooctenecarboxylic acid, cyclodecenecarboxylic acid, cyclopentenol, cyclooctenol, or a mixture thereof.

4. The process as claimed in claim 1, wherein the reaction of one or more H-functional starter substance and one or more alkylene oxide is conducted in the presence of a double metal cyanide (DMC) catalyst and of carbon dioxide.

5. The process as claimed in claim 4, comprising
(α) optionally, initially charging a portion of the H-functional starter substance and/or a suspension medium containing no H-functional groups in a reactor, in each case optionally together with DMC catalyst,
(β) optionally, adding a portion of alkylene oxide to the mixture from step (α) at temperatures of 90 to 150° C., and halting the addition of the alkylene oxide compound, and
(γ) continuously metering one or more H-functional starter substance(s) into the reactor during the reaction.

6. The process as claimed in claim 1, wherein the alkylene oxide comprises propylene oxide, ethylene oxide, 1-butylene oxide, 1-hexene oxide, 1-dodecene oxide, epichlorohydrin, methyl glycidyl ether, ethyl glycidyl ether, butyl glycidyl ether, dodecyl glycidyl ether, tetradecyl glycidyl ether, methoxyethyl glycidyl ether, methoxyethoxyethyl glycidyl ether, allyl glycidyl ether, phenyl glycidyl ether, cresyl glycidyl ether, furfuryl glycidyl ether, benzyl glycidyl ether, tetrahydrofurfuryl glycidyl ether, or mixtures thereof.

7. Polyoxyalkylene macromers comprising the reaction product of an H-functional starter substance and an alkylene oxide, in the presence of a catalyst, wherein said H-functional starter substance comprises a carbon-carbon double bond which is part of a cyclic structure, and wherein the H-functional starter substance and the alkylene oxide are continuously metered into the reactor.

8. The polyoxyalkylene macromers as claimed in claim 7, wherein the polyoxyalkylene macromer has a CO₂ content of 3% by weight to 35% by weight, wherein the CO₂ content has been determined by means of ¹H NMR.

9. The polyoxyalkylene macromers as claimed in claim 7, wherein the polyoxyalkylene macromer wherein has a number-average molecular weight Mₙ of ≥500 g/mol to ≤1 000 000 g/mol, which has been determined by means of GPC.

10. The polyoxyalkylene macromers as claimed in claim 7, wherein the polyoxyalkylene macromer has a glass transition temperature T_{g} of ≥−80° C. mol to ≤−1° C.

11. A process for preparing polyoxyalkylene brush polymers, comprises reacting a polyoxyalkylene macromer as claimed in claim 7 with an olefin metathesis catalyst.

12. The process as claimed in claim 11, wherein the reaction is additionally conducted in the presence of a cyclic olefin.

13. The process as claimed in claim 11, wherein the olefin metathesis catalyst comprises a ruthenium carbene complex(es) which comprises dichloro[1,3-bis(2,4,6-trimethylphenyl)-2-imidazolidinylidene](benzylidene)bis(3-bromopyridine)ruthenium(II), dichloro[1,3-bis(2,4,6-trimethylphenyl)-2-imidazolidinylidene](2-isopropoxyphenylmethylene)ruthenium(II), dichloro(benzylidene)bis(tricyclohexylphosphine)ruthenium(II), dichloro[1,3-bis(2-methylphenyl)-2-imidazolidinylidene](2-isopropoxyphenylmethylene)ruthenium(II), and mixtures thereof.

14. Polyoxyalkylene brush polymers comprising the reaction product of the polyoxyalkylene macromer of claim 7 with an olefin metathesis catalyst.

15. Crosslinked polyoxyalkylene polymers comprising:
(i) the reaction product of polyoxyalkylene brush polymers which contain an OH end group as claimed in claim 14 with polyisocyanates;
(ii) the reaction product of polyoxyalkylene brush polymers which contain an OH end group as claimed in claim 14 with polycarboxylic acids or cyclic carboxylic anhydrides;
or
(iii) the free-radical of polyoxyalkylene brush polymers as claimed in claim 14.
